(19) United States
(12) Patent Application Publication
(10) Pub. No.: US 2016/0335678 A1
(43) Pub. Date: Nov. 17, 2016

(54) Collective Expansion of Bid-Terms for Campaign Optimization

(71) Applicant: Yahoo! Inc., Sunnyvale, CA (US)

(72) Inventors: Nagaraj Kota, Sunnyvale, CA (US); Srinath Mandalapu, Santa Clara, CA (US); Anthony Thaniserikaran Devassy, San Jose, CA (US)

(21) Appl. No.: 14/713,811

(22) Filed: May 15, 2015

(51) Int. Cl. G06Q 30/02

(52) U.S. Cl. CPC G06Q 30/0275; G06Q 30/0277

(57) ABSTRACT

Systems and methods for building an index for matching queries and bidded terms are disclosed. The expansion of the bid-terms includes a collective expansion using graph mining techniques on a subgraph extracted from user actions on a <query, URL> bi-partite graph. The extracted subgraph is specific to an AdGroup (obtained using all the available context) and is personalized. The extracted subgraph can be tuned to various objectives such as head/torso/tail, specific vs generic etc. Multiple relevance measures of candidate query nodes are calculated with reference to multiple source nodes or context, and the final rankings are biased to commercial relevance using personalized random-walks.

### BACKGROUND

1. Technical Field

The disclosed embodiments are related to Internet advertising and more particularly to systems and methods for sponsored search ad matching and building an index for ad matching with expanded bid terms in a sponsored search marketplace.

2. Background

Internet advertising is a multi-billion dollar industry and is growing at double-digit rates in recent years. It is also the major revenue source for internet companies such as Yahoo!® that provide advertising networks that connect advertisers, publishers, and Internet users. As an intermediary, these companies are also referred to as advertiser brokers or providers. New and creative ways to attract attention of users to advertisements (“ads”) or to the sponsors of those advertisements help to grow the effectiveness of online advertising, and thus increase the growth of sponsored and organic advertising. Publishers partner with advertisers, or allow advertisements to be delivered to their web pages, to help pay for the published content, or for other marketing reasons.

Search engines assist users in finding content on the Internet. In the search ad marketplace, ads are displayed to a user alongside the results of a user's search. Ideally, the displayed ads will be of interest to the user resulting in the user clicking through an ad. In order to increase the likelihood of displaying an ad to a user, an advertiser creates ad-groups with bids on keywords, or bid-terms, and specify a matching criteria against the user search query as EXACT, BROAD, or PHRASE, i.e. the advertiser bid-terms should match exactly, or be semantically related, or appears as a phrase in the original user search query. While an advertiser may be able to easily identify bid-terms based on their knowledge of the market, other bid-terms may escape the advertiser. These bid-terms represent a lost opportunity for the advertiser to display their ad to an interested user, as well as a lost sales opportunity for the ad broker.

Because the search provider often has the most information regarding query searches and user behavior, they are often the best situated to match advertiser keywords with bid-terms that may otherwise be overlooked by an advertiser. To help the advertiser, and to increase their search ad marketplace, brokers in the past have developed systems for rewriting user queries to match more advertiser bid-terms. These systems may be relatively simple, such as a broker manually entering words they believe to be related, to more advanced techniques such as query-log mining, based on related searches, co-biddedness, based on advertisers bidding on similar bid-terms, and search uniform resource locator (URL) overlap, in which different queries result in the same set of search URLs.

The described systems are each successful in their own way to match queries with AdGroup bid-terms, but they may lack context that may be necessary for proper matching. For example, an advertiser may be interested in promoting intent of “transformers 3d ride™” AdGroup bid-terms may include lists such as “universal studios transformers”, “transformers ride universal studios™”, “transformers ride”, and “transformers”. If a user were to search using the query “bumblebee movie™”, conventional systems may rewrite the query to “transformers™”, which matches one of the bidded-terms of the AdGroup. The user would then be shown ads related to the transformers ride attraction in universal studios as part of the advertising campaign. Despite the rewritten query matching a bid-term, the user is actually interested in the movie, and not in the ride the advertiser is targeting. This lack of relevance is due to limited context available at source side query expansion.

Thus, there exists a technical problem of how to match a user query in a manner that provides for more matches between queries and bid-terms, while taking into consideration the context of the group of bid-terms. The particular context of the problem is described herein as a sponsored-search system in which queries are matched to bid-terms an advertiser may be bidding on. However, the solutions described herein may be readily extended to other database searching and query satisfaction systems.

### BRIEF SUMMARY

It would be beneficial to develop a system for expanded bidded terms using additional context of an advertisers bidded terms. If a larger number of queries are matched that are still relevant to the advertisers bidded terms, it will increase the number and quality of opportunities for an advertiser to reach their target audience, while additionally increasing the sales of the ad broker.

In one aspect of the disclosure, a method for creating an index for expanding bidded terms is described. The method includes receiving a group of bid-terms, accessing a query-uniform resource locator graph with the graph having query nodes, uniform resource locator (URL) nodes, and edges modeling transition probabilities between nodes, extracting a local sub-graph from the query-URL graph for each bid-term among the group of bid-terms to derive a plurality of sub-graphs comprising a bid-term seed node, related URL nodes, and candidate bid-term nodes, merging the local subgraphs to form a merged graph, annotating the merged graph with additional information, computing the sum of probabilities across all paths between each bid-term seed node and each candidate bid-term node, computing a relevance score for each candidate bid-term node, constructing a preference vector for the merged graph to bias for highly bidded source terms and relevant bidded candidates, scoring the candidate bid-term nodes of the merged graph using the preference vector, computing a probability of reaching a candidate node from a seed node, and attributing each candidate node of the merged graph to a seed node having the highest probability of reaching the candidate node.

In some embodiments, the method further includes computing a utility for sets of URLs between each bid term seed node and each candidate bid term node, and pruning the candidate bid term nodes based on the computed utility.

In some embodiments, the method further includes computing a probability for each path from a bid term seed node to each related bid term node for each local sub-graph, and pruning the local subgraphs based on the computed probability.

In some embodiments, the query-uniform resource locator graph is derived from a search log. In some embodiments, the additional information for the annotated graph is selected from the list consisting of number of clicks for each query node, the number of advertisers bidding on each query node, the number of clicks to a specific URL for each edge, the total number of queries linked to each URL node, the total number of clicks for each URL, and the total number of linked Queries for each URL.

In another aspect of the disclosure, a method for creating an index for expanding bidded terms is disclosed. The method includes accessing a query-uniform resource locator graph with the graph having query nodes, uniform resource locator (URL) nodes, and edges modeling transition probabilities between nodes, extracting a local sub-graph from the query-URL graph for each bid term among a group of bid terms to derive a plurality of sub-graphs comprising a bid term seed node, related URL nodes, and candidate bid term nodes, merging the local subgraphs to form a merged graph, personalizing the merged graph, computing at least one relevance measure for each candidate bid term node with respect to each bid term seed node, and ranking the candidate bid term nodes for each bid term seed node, the ranking biased according to commercial relevance.

In some embodiments, the method further includes pruning the local sub-graphs prior to merging.

In some embodiments, the query-uniform resource locator graph is derived from a search log. In some embodiments, ranking the candidates includes a personalized page rank of the merged graph.

In another aspect of the disclosure, a system for serving advertisements related to a user query is disclosed. The system includes an indexing module configured to access a query-uniform resource locator graph, the graph comprising query nodes, uniform resource locator (URL) nodes, and edges modeling transition probabilities between nodes, extract a local sub-graph from the query-URL graph for each bid term among a group of bid terms to derive a plurality of sub-graphs comprising a bid term seed node, related URL nodes, and candidate bid term nodes, merge the local subgraphs to form a merged graph, personalize the merged graph, compute at least one relevance measure for each candidate bid term node with respect to each bid term seed node, and rank the candidate bid term nodes for each bid term seed node, the ranking biased according to commercial relevance, and a matching module configured to receive a user query, match the user query with at least one bid term node from among the ranked bid term nodes and a seed bid term node, and select an advertisement basted on the matched bid term.

In some embodiments, the system further includes a storage module configured to store the ranking of the candidate bid term nodes.

In some embodiments, the system further includes an ad serving module configured to serve the selected advertisement.

In some embodiments, the system further includes a memory storing a search engine log for deriving the query uniform resource locator log.

### BRIEF DESCRIPTION OF THE DRAWINGS

FIG. 1 illustrates an exemplary embodiment of a network system suitable for practicing the invention.

FIG. 2 illustrates a schematic of a computing device suitable for practicing the invention.

FIG. 3 illustrates an example query-URL graph.

FIG. 4 illustrates a click graph showing queries leading to a common URL.

FIG. 5 illustrates a click graph of a query and related URLs.

FIG. 6 illustrates a click graph showing a path between a source query and a candidate query.

FIG. 7 illustrates an annotated click graph.

FIG. 8 illustrates an example query-URL click graph.

FIG. 9 illustrates an example AdGroup click graph.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The claimed subject matter is related to monetization of sponsored search advertising. Various monetization techniques or models may be used in connection with sponsored search advertising, including advertising associated with user search queries, or non-sponsored search advertising, including graphical or display advertising. In an auction type online advertising marketplace, advertisers may bid in connection with placement of advertisements, although other factors may also be included in determining advertisement selection or ranking. Bids may be associated with amounts advertisers pay for certain specified occurrences, such as for placed or clicked on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

The disclosed subject matter further relates to systems and methods for building an index for expanding bidded terms and to systems and methods for expanding bidded terms. The described systems and methods are able to build an index for expanding bidded terms that accounts for the context of the bidded terms provided by an advertiser. The index may then be used to expand bidded terms to increase matching between organic queries and bid-terms.

When a user enters a search query at a client device, the search query is sent to a search engine and the search engine returns search results related to the query for display on a search results page at the client device. Additionally, the query is sent to an ad network, which uses a matching algorithm to match an expanded set of bidded terms with the query to identify an advertisement for serving.

### Ad Network

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

### Network

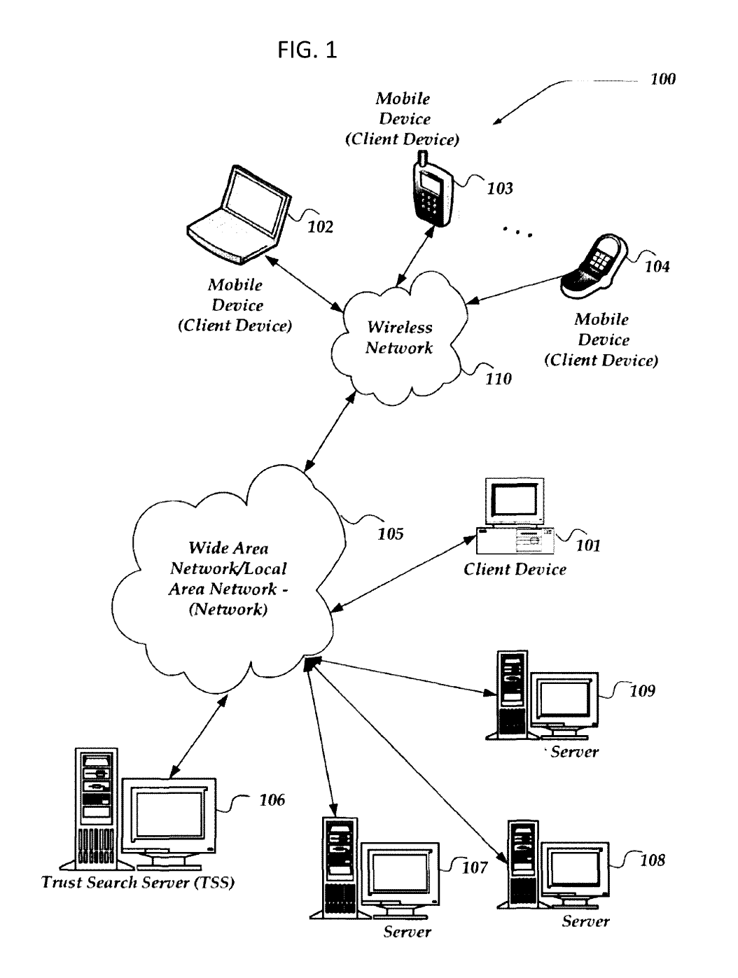

FIG. 1 is a schematic diagram illustrating an example embodiment of a network 100 suitable for practicing the claimed subject matter. Other embodiments may vary, for example, in terms of arrangement or in terms of type of components, and are also intended to be included within claimed subject matter. Furthermore, each component may be formed from multiple components. The example network 100 of FIG. 1 may include one or more networks, such as local area network (LAN)/wide area network (WAN) 105 and wireless network 110, interconnecting a variety of devices, such as client device 101, mobile devices 102, 103, and 104, servers 107, 108, and 109, and search server 106.

The network 100 may couple devices so that communications may be exchanged, such as between a client device, a search engine, and an ad server, or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

### Computing Device

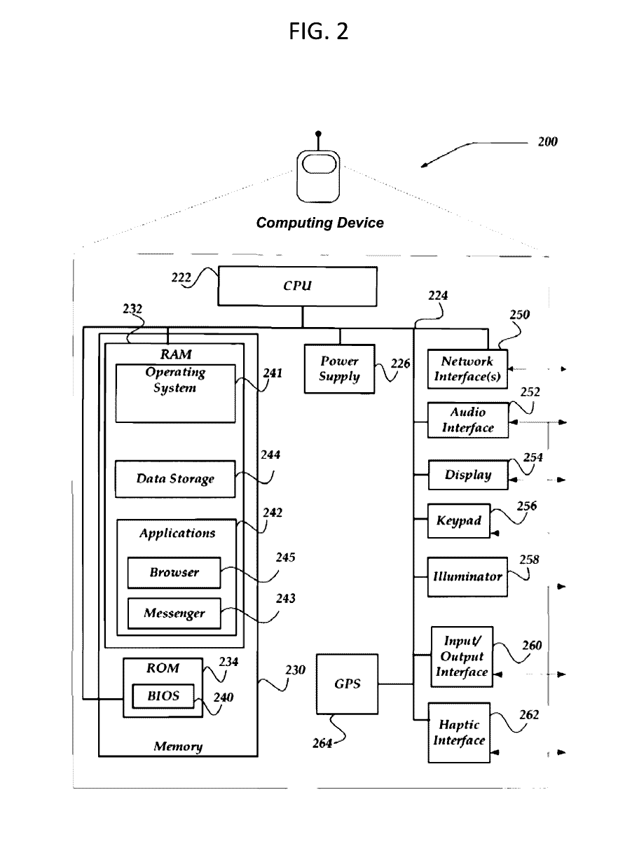

FIG. 2 shows one example schematic of an embodiment of a computing device 200 that may be used to practice the claimed subject matter. The computing device 200 includes a memory 230 that stores computer readable data. The memory 230 may include random access memory (RAM) 232 and read only memory (ROM) 234. The ROM 234 may include memory storing a basic input output system (BIOS) 230 for interfacing with the hardware of the client device 200. The RAM 232 may include an operating system 241, data storage 244, and applications 242 including a browser 245 and a messenger 243. A central processing unit (CPU) 222 executes computer instructions to implement functions. A power supply 226 supplies power to the memory 230, the CPU 222, and other components. The CPU 222, the memory 230, and other devices may be interconnected by a bus 224 operable to communicate between the different components. The computing device 200 may further include components interconnected to the bus 224 such as a network interface 250 that provides an interface between the computing device 200 and a network, an audio interface 252 that provides auditory input and output with the computing device 200, a display 254 for displaying information, a keypad 256 for inputting information, an illuminator 258 for displaying visual indications, an input/output interface 260 for interfacing with other input/output devices, haptic feedback interface 262 for providing tactile feedback, and a global positioning system 264 for determining a geographical location.

### Client Device

A client device is a computing device 200 used by a client and may be capable of sending or receiving signals via the wired or the wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features and need not contain all of the components described above in relation to a computing device. Similarly, a client device may have other components that were not previously described. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

### Servers

A server is a computing device 200 that provides services, such as search services, indexing services, file services, email services, communication services, and content services. Servers vary in application and capabilities and need not contain all of the components of the exemplary computing device 200. Additionally, a server may contain additional components not shown in the exemplary computing device 200. In some embodiments a computing device 200 may operate as both a client device and a server.

An “ad server” comprises a server that stores online advertisements for presentation to users. “Ad serving” refers to methods used to place online advertisements on websites, in applications, or other places where users are more likely to see them, such as during an online session or during computing platform use, for example.

### Graphs

The claimed subject matter uses traditional computer science concepts such as graphs. Graphs are a technique for representing data in the form of nodes and their relationships in the form of interconnected edges. One of ordinary skill in the art would be familiar with traditional graph traversal and manipulation. For example, one would be familiar with traversal techniques such as a depth-first search, a breadth-first search, random walks, etc. and with manipulations such as graph inversion or reversal.

One of ordinary skill in the art would recognize traditional graph algorithms such as finding a path between two nodes and techniques for finding the shortest path from one node to another. Furthermore, algorithms for ranking graph nodes are well known in the art, such as PageRank, Topic-Sensitive PageRank, absorption probabilities, preference vectors, random walks, and other algorithms.

### Overview of Collective Expansion of Bid-Terms

Embodiments of the disclosed subject matter use context available in a group of bid-terms to expand the provided bid-terms. Using the example AdGroup of “transformers 3D ride” having bidded terms such as “universal studios transformers”, “transformers ride universal studios”™, “transformers ride™”, and “transformers™”, the bid-term “transformers” is implicitly expanded to include additional, related bid-terms such as “transformers ride at universal™” and “universal transformers ride™”. This expansion biases the matching algorithm to include a “ride” concept more than a “movie” concept. The additional context for providing this implicit expansion may include high performing search queries previously issued on this AdGroup, landing page keywords, or any other sources. Once these additional keywords are inferred, they are attributed to one of the BROAD bid-terms in the AdGroup, and treated as implicit BROAD terms. At the time of serving an advertisement, for a given user search query, the query is looked up against the extended bid terms, as well as explicit bid terms, and the eligible ads are selected through their respective matching criteria. This results in increased precision/recall in matching due to the fact that, the queries are matched against the inferred search bid-terms which yields a higher return on investment (ROI) for an advertiser, and search marketplace key performance indicator (KPI)s.

The expansion of the bid-terms includes a collective expansion using graph mining techniques on a subgraph extracted from user actions on a <query, URL> bi-partite graph. The extracted subgraph is specific to an AdGroup (obtained using the entire available context) and is personalized. The extracted subgraph can be tuned to various objectives such as head/torso/tail, specific vs. generic, etc. Multiple relevance measures of candidate query nodes are calculated with reference to multiple source nodes or context, and the final rankings are biased to commercial relevance using personalized random-walks.

The expansion of bid-terms should generate new bid-terms relevant to the source bid terms, driving higher ad coverage and depth in the search market place. A query/uniform resource locator (URL) graph is used to find key words that are relevant to the bid-terms. Intuitively, a URL is said to be close to a query if freq(q,URL) dominates the number of clicks on the URL. In other words, most people user query q to access the URL. Similarly, a query is said to be close to a target query if it is close to many URLs that are close to the target query.

### Initial Candidate Generation

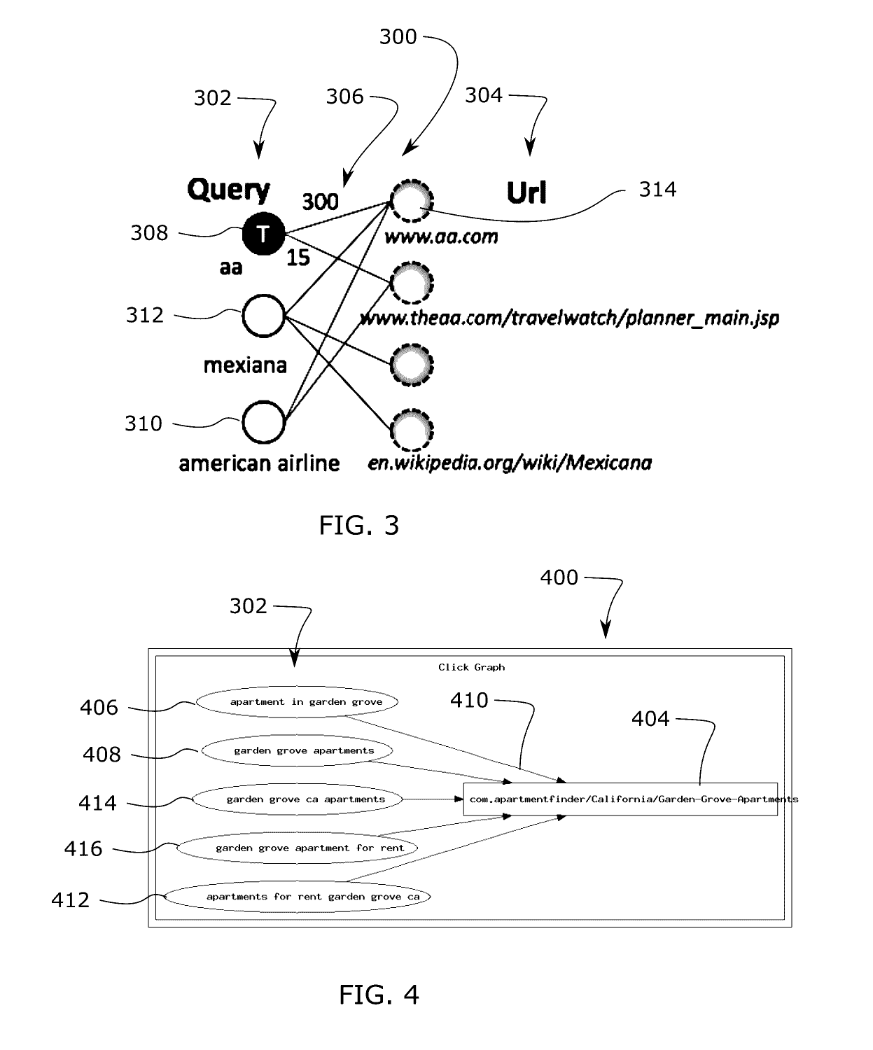

FIG. 3 illustrates a portion of an exemplary query-URL graph having query nodes 302 and URL nodes 304 connected by edges 306. An actual query-URL graph could contain millions of nodes linked by edges, rather than the seven nodes 302, 304 illustrated here. Search logs contain a set of URLs, U=u1, u2, u3, . . . , un, that users have historically clicked on in response to a set of queries Q=q1, . . . , qn. There is a directed edge 306 between a query node 302 qi and a URL node 304 uj if at least one user clicked uj in the result page of the query qi. There is a weight on each edge 306 computed based on the number of times uj was clicked as result of query qi. If two queries nodes 302 are linked by the same URL node 304, they will be considered relevant.

Referring to FIG. 3, a bidded term is considered to be a source query node 308 in the query-URL graph 300. Initially, candidate query nodes 310, 312 are generated using the query-URL graph 300. For example, in FIG. 3, source query node 308 “aa” would be related to candidate query nodes “mexiana” 312, and “american airline” 310 by virtue of each of the queries nodes 310, 312 linking to the URL node www.aa.com 314.

FIG. 4 illustrates a click graph 400 showing queries 402 that lead to a common URL 404. There are two source queries 406, 408 linked to the Garden-Grove-Apartments URL 404. This indicates that past users have clicked on the Garden-Grove-Apartments URL 404 after searching using either of these queries 406, 408. The weight on the edge 410 is representative of how many clicks led from the query 406 to the URL 404.

In addition to the two source queries 406, 408, there are three adjacent queries 412, 414, 416 that lead to the same URL 404. These are queries 412, 414, 416 that were not bid upon by the advertiser, but that still lead to the same URL 404 in the based on the search log. These queries 412, 414, 416 may be linked to the source queries 406, 408 as related since they each lead to the same URL 404. The linked queries 412, 414, 416 are considered to be candidate queries that may be used as expanded bidded terms. In this example, although the advertiser bid on only two queries 406, 408, there are five candidate queries 406, 408, 412, 414, 416 to which their ads may match, thereby expanding the advertiser's coverage.

### Pruning Candidates

The example of FIG. 4 resulted in a set of five initial candidates for the two source queries 406, 408. In a real world example, the set of initial candidates is typically much greater than five. Particularly, as the number of steps of relatedness is increased, the number candidates may increase exponentially. For example, if instead of using two transitions, as shown in FIG. 4, the set of initial candidates is instead based on four transitions, i.e. query-URL-query-URL-query, instead of five candidates, there may be twenty-five candidates, assuming each URL had five queries leading to it.

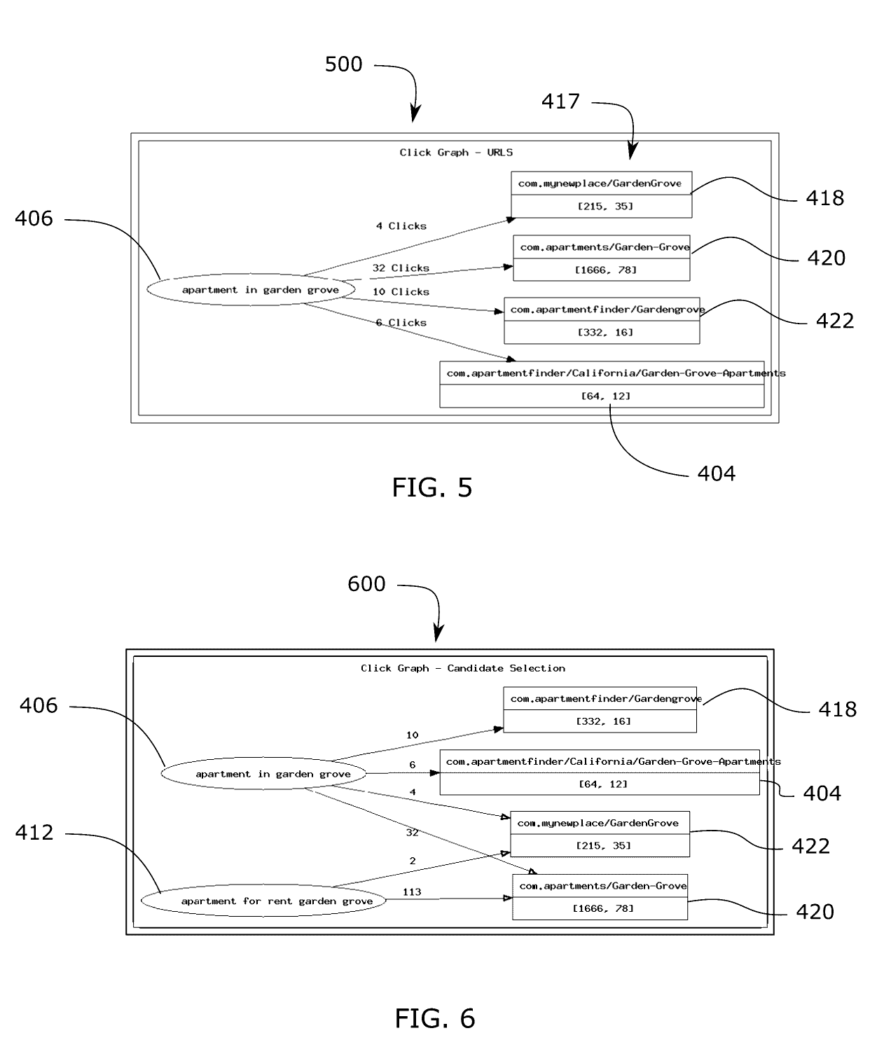

Rather that working with a large number of queries, it is useful, but not essential, to prune the candidate queries. Returning to the simplified example of FIG. 4, when users searched for the query “apartment in garden grove” 406, they sometimes subsequently clicked on the Garden-Grove-Apartments URL 404. However, they did not always click on the Garden-Grove-Apartments URL 405. FIG. 5 illustrates a click graph 500 of a query 406 and the related URLs 417. As shown in FIG. 5, there were four different URL's 417 that users clicked through when using query 406. Each URL is labeled with the total number of clicks 425 on that URL and the total number of queries that link to the URL. For example, the first query 418 had 215 clicks and 35 queries linked to it. In this example, for the “apartment in garden grove” query 406, there is a possible set of 137 candidates (the total of the URLs linked to each of the queries minus the 4 edges directed to the source query 406).

The set of candidates may be pruned by normalizing the click count from query->URL using the Inverse Document Frequency. The click counts are adjusted based on the number of queries that linked to the URL. Click counts to more popular URLs are less valuable than click counts to lesser known URLs. The normalized click count is given as log((total number of queries)/(number of queries to the URL))*(query_url clicks). For example, the click count for “apartment in garden grove” 406->Garden Gove Apartment URL 404 may be adjusted as log(10̂7/12)*6=37.

It is useful to define a transition probability p[ij] from a node i (query) to a node j (URL) based on click counts i->j divided by di, where di is the sum of click counts across all URL nodes connected to i (query node). In the example of FIG. 4, the transition probability between “apartment in garden grove” 406 and the “Garden-Grove-Apartments” URL 404 is give as 6 clicks/(6|10|32|4 total clicks)=0.11.

FIG. 6 illustrates a click graph 600 showing a path between a source query 406 and a candidate query 412. A random walk is done on the subgraph (the candidate nodes) by defining the transition probably between query i and query j in V1 as

$${p}_{i , j} = {\sum }_{k ∈ {V}_{2}} \frac{w ( i , k )}{{d}_{i}} \frac{w ( k , j )}{{d}_{k}} .$$

In the following example, transition probability between source query “apartment in garden grove” 406 and candidate query “apartment for rent garden grove” 412 is found as follows:

| | |
|---|---|
| a. | Path 1: apartment in garden grove 406 −> com.apartments/Garden- |
| | Grove 420 −> “apartment for rent garden grove” 408 |
| b. | Path 2: “apartment in garden grove” 406 −> com.mynewplace/ |
| | GardenGrove 422 −> “apartment for rent garden grove^{••} 408 |
| c. | [apartment in garden grove 406 −> com.apartments/Garden-Grove |
| | 420] => Path 1 transition probability + Path 2 transition probability. |

The path 1 transition probability is

| | |
|---|---|
| a. | [apartment in garden grove 406 −> com.apartments/Garden-Grove |
| | 420] * [com.apartments/Garden-Grove 420* apartment for rent |
| | garden grove 412] = 0.03774489031 |
| b. | Similarly, the path 2 transition probability is = 0.001000165203 |

The candidate queries are then pruned by setting a threshold transition probability. Candidate queries having a transition probability less than the threshold are not considered, while candidate queries having a transition probability greater than the threshold are considered.

### Grouping Source Queries and Candidate Queries by AdGroup

Once the candidate queries have been pruned to include only those candidate queries having an acceptable transition probability, a query-click graph by AdGroup is created using the original query-URL click graph. Table 1 is an example query AdGroup table. The query “apartment in garden grove” 406 belongs to three different ad groups.

TABLE 1

| Bidded Term | Ad Group Id | Price | Type |
|---|---|---|---|
| apartment in garden grove | 7200631559 | 0.3 | BROAD |
| apartment in garden grove | 7200697761 | 0.3 | BROAD |
| apartment in garden grove | 7245489994 | 0.05 | BROAD |

The same source query may appear in multiple AdGroups. In the previous example, the source query “apartment in garden grove” could appear in three ad groups, with each ad group having its own associated AdGroup Id. In the previous step, a set of possible candidates was found for each source query.

Each source query is labeled with an AdGroup ID based on the AdGroup that it is a part of. If a source query belongs to more than one AdGroup, then the source-target queries are replicated across each of the AdGroups. All of the source and target queries for a given AdGroup are then grouped together. Each AdGroup contains all of the source queries within the AdGroup and all target queries for the source queries of the AdGroup. The cumulative transitional probabilities for each of the candidates is then computed across multiple source queries.

Once again, a threshold may be applied to find only those target queries having a transitional probability exceeding a set threshold. If an AdGroup does not contain at least one bidded term, then it is not necessary to generate any candidates for that group. Once the threshold has been applied, the result is a set containing all source queries and target candidates for a given AdGroup id.

### Annotating the Filtered Click Graph for Source and Target Queries

Each AdGroup id contains a Query-URL click graph 700 containing only the original source queries 406, 408 and the candidate queries 414, 416 along with the linked URLs 404, 420 between the source queries and the candidate queries. The graph 700 is annotated with relevant information such as the number of clicks for each query, the number of advertisers bidding on each query, the number of clicks to a specific URL for each edge, the total number of queries linked to each URL, the total number of clicks for each URL, and the total number of linked Queries for each URL.

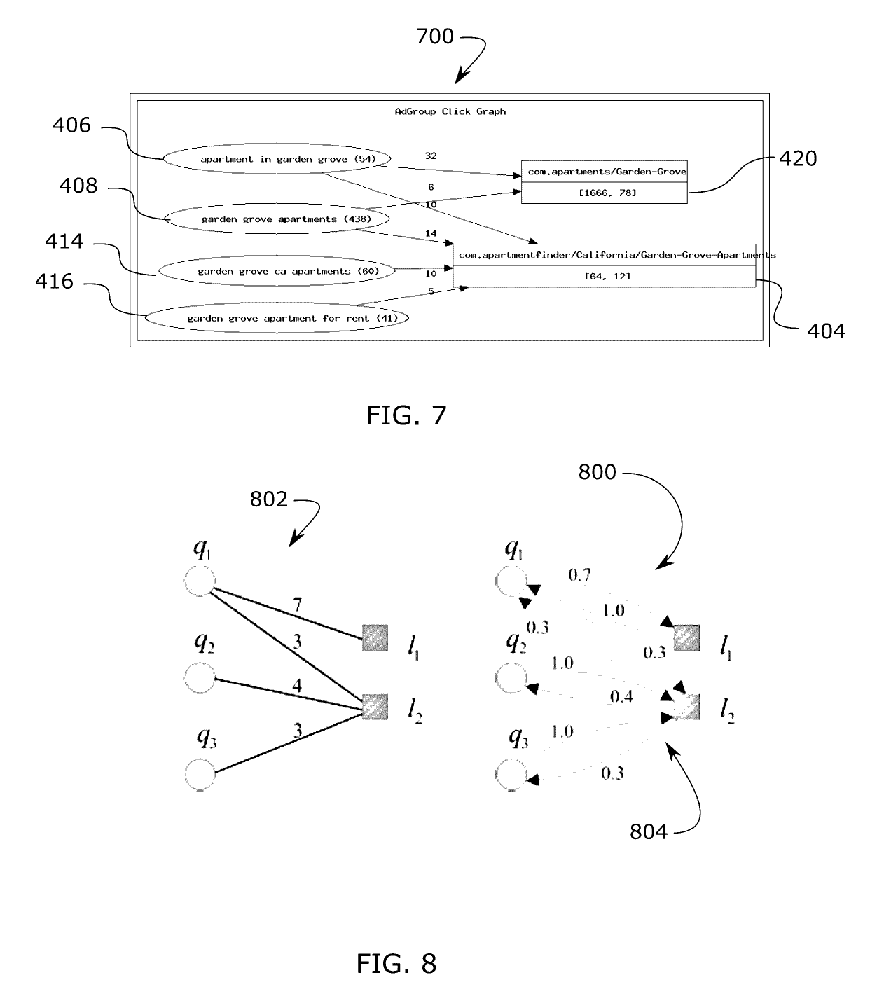

FIG. 7 illustrates a click graph 700 annotated in this manner. The source query “apartment in garden grove” 406 has a total number clicks of 54 and the edge leading to the Garden-Grove URL 420 has 32 clicks. The Garden-Grove URL 420 has one thousand, six hundred, and sixty-six total clicks and seventy-eight queries that lead to it. This figure is merely illustrative and a real world example would have many more queries and linked URLs.

### Compute Forward/Backward Transition Probabilities in AdGroup Click Graph

The transition probabilities between a source/candidate query and URL is then computed for the annotated graph 700 for each edge. FIG. 8 is an example showing Forward/Backward transition probabilities in query-URL click graph 800. The weight on a directed query-URL edge is normalized by the number of times that the query is issued, while the weight on a directed URL-query edge is normalized by the number of times that URL is clicked. FIG. 8 shows an example of an unweighted click graph and its associated weighted click graph 804. The weight from q1 to l1 is seven clicks divided by seven plus three clicks and from q1 to l1 is three clicks divided by three plus seven clicks. Going from l1 to q1 the weight is seven clicks divided by seven clicks and from l2 to q1 the weight is three clicks divided by ten clicks.

For example, as shown in FIG. 4, the source query “apartment in garden grove” 406 is connected to 4 URLs. Table 2 shows the links URLs, clicks, and ad clicks for the source query “apartment in garden grove” 406. Clicks represent all clicks between the source URL and the URL. Ad clicks represents clicks on the URL when the URL is presented as an ad.

TABLE 2

| | | | | Ad |
|---|---|---|---|---|
| | Query | URL | Clicks | Clicks |
| 7200631559 | apartment in | com.mynewplace/ | 4 | 3 |
| | garden grove | GardenGrove | | |
| 7200631559 | apartment in | com.apartmentfinder/ | 10 | 10 |
| | garden grove | Gardengrove | | |
| 7200631559 | apartment in | com.apartmentfinder/ | 6 | 0 |
| | garden grove | California/Garden- | | |
| | | Grove-Apartments | | |
| 7200631559 | apartment in | com.apartments/ | 32 | 32 |
| | garden grove | Garden-Grove | | |

Table 3 shows the URL statistics for each of the URLs in table 2.

TABLE 3

| Ad Group | URL | Clicks | Query Cnt |
|---|---|---|---|
| 7200631559 | com.mynewplace/GardenGrove | 215 | 35 |
| 7200631559 | com.apartmentfinder/Gardengrove | 332 | 16 |
| 7200631559 | com.apartmentfinder/California/ | 64 | 12 |
| | Garden-Grove-Apartments | | |
| 7200631559 | com.apartments/Garden-Grove | 1666 | 78 |

Table 4 shows an example of the source/target queries that are linked to the third URL of table 3. Each edge in a query URL graph contains clicks on the URL and ad clicks when the URL was presented as an advertisement. Because the number of target queries was pruned previously, not all source/target queries present in the original graph are present.

TABLE 4

| | | | | Ad |
|---|---|---|---|---|
| Ad Group | URL | Query(Source/Target) | Clicks | Clicks |
| 7200631559 | com.apartmentfinder/California/Garden-Grove-Apartments | apartments in garden | 9 | 0.0 |
| | | grove | | |
| 7200631559 | com.apartmentfinder/California/Garden-Grove-Apartments | apartments for rent in | 6 | 0.0 |
| | | garden grove ca | | |
| 7200631559 | com.apartmentfinder/California/Garden-Grove-Apartments | apartment for rent in | 2 | 0.0 |
| | | garden grove ca | | |
| 7200631559 | com.apartmentfinder/California/Garden-Grove-Apartments | apartment in garden | 6 | 0.0 |
| | | grove | | |
| 7200631559 | com.apartmentfinder/California/Garden-Grove-Apartments | garden grove | 4 | 0.0 |
| | | apartments | | |
| 7200631559 | com.apartmentfinder/California/Garden-Grove-Apartments | apartments for rent in | 5 | 0.0 |
| | | garden grove | | |
| 7200631559 | com.apartmentfinder/California/Garden-Grove-Apartments | garden grove ca | 4 | 0.0 |
| 7200631559 | com.apartmentfinder/California/Garden-Grove-Apartments | garden grove | 2 | 0.0 |
| | | apartment for rent | | |
| 7200631559 | com.apartmentfinder/California/Garden-Grove-Apartments | apartments garden | 4 | 0.0 |
| | | grove ca | | |
| 7200631559 | com.apartmentfinder/California/Garden-Grove-Apartments | apartments for rent | 5 | 0.0 |
| | | garden grove ca | | |
| 7200631559 | com.apartmentfinder/California/Garden-Grove-Apartments | apartments in garden | 7 | 0.0 |
| | | grove ca | | |
| 7200631559 | com.apartmentfinder/California/Garden-Grove-Apartments | garden grove ca | 5 | 0.0 |
| | | apartments | | |

The forward/backward transition probabilities between a query and a URL is computed as follows. For a backwards transition, moving from a URL to a query, the probability is found by dividing the number of clicks for the edge by the total number of clicks on the URL. For example, the probability of moving from the third URL to the query “apartment in garden grove” is equal to 6/64, or about 0.1. The forward transition probability is calculated as the number of clicks for an edge divided by the total number of clicks for the source. However, the clicks are adjusted by log(10̂6/number of queries linked to the URL). For example, the probability of moving from the query “apartment in garden grove” to the third URL would be log(10̂6/12)/64=0.077.

### Ranking Query Suggestions by Hitting Probabilities (With Source Queries)

Once the forward/backward transition probabilities are found for the graph, the candidate queries are ranked based on hitting probabilities with source queries within an AdGroup. The hitting probabilities estimate how long it would take to hit a particular node with a random walk starting at a different node. It is a proximity measure of relatedness of nodes. The expected proximity of a first query to a second query is proportional to the hitting time of the first query->second query.

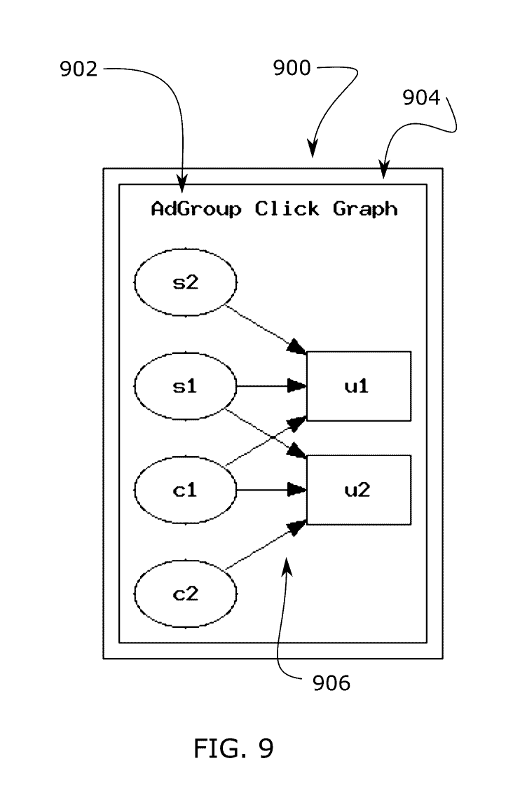

FIG. 9 illustrates an AdGroup Click Graph 900 having four query nodes 902 and two URL nodes 904 along with various edges 906 between the nodes 902, 904. Two of the query nodes 902 are source nodes s1, s2, and two are candidate nodes c1, c2. The goal for this simplified graph 900 is to rank the candidate nodes c1, c2 with respect to their hitting probabilities with the source queries s1, s2.

The vector of hitting probabilities h^{A}=(hᵢ^{A}:i∈I) is the minimal non-negative solution to the system of linear equations

$$\{ \begin{matrix}{h}_{i}^{A} = 1 & for i ∈ A \\ {h}_{i}^{A} = {\sum }_{j ∈ I} {p}_{i , j} {h}_{j}^{A} & for i ∉ A\end{matrix}$$

In the example of FIG. 9, the hitting probabilities of the first candidate c1 and the second candidate c2 need to be calculated with respect to the first source query s1 and second source query s2. For the source queries s1, s2, the probability of them hitting themselves is 1. However, the hitting probability for a source query is adjusted to account for its bid price relative to the total bid amount for the source queries. For example, if s1 has a bid price of $1.00 and s2 has a bid price of $2.00, then the adjusted hitting probability of s1 would be ⅓ and s2 would be ⅔.

The hitting probability of candidates c1 and c2 with respect to the source queries s1 and s2 via u1 and u2 can be found using a random walk on the graph 900. s1 can be reached from c1 via u1 and u2. For u1, p(s1->c1)=p(s1->u1)*p(u1->c1) (forward transition probability) and for u2 p(s1->c1)=p(s1->u2)*p(u2->c1) (again forward transition probability). The sum of the probability along u1 and u2 is then multiplied by the weight of s1, with may be according to bid price. s2 can only be reached from c1 via u1 and p(s2->c1)=p(s2->u2)*p(u2->c1). This probability is then multiplied with weight of s2 (according to bid price).

Additionally, it is possible to reach s1 and s2 through other candidates from c1. In this example, c2 can be reached from c1 via u2, then use hitting probability of c2 with sources s1 and s2. Therefore the hitting probability for c2 with sources s1 and s2 is p(c1->c2)*hitting probability of h(c2)·p(c1->c2)=p(c1->u2)*p(u2->c2)

This recursive set of equations may then be used to compute the hitting probability using an iterative process. This may be done by setting h(c1) and h(c2) to zero and computing h(c1) and h(c2) in each iteration until h(c) stabilizes. Finally, the total hitting probability for h(c1) may be found by summing the probability for each source node multiplied by the weight for that node and the probability through any other candidates. The hitting probabilities of candidates is also calculated using the backward transitional probability. The transitional probabilities are not symmetrical, p(s1->c1) is not equal to p(c1->s1). p(s1->c1)=p(s1->u1)*p(u1->c1) and p(c1->s1)=p(c1->u1)*p(u1->s1). The hitting probability using backward transition probability p(c1->s1) can be computed by repeating the above procedure. Once the forward and reverse hitting probability is found, the hitting probability of each candidate is calculated as a geometric mean of the forward and backward hitting probability.

### Ranking Query Suggestions by Personalized PageRank

The PageRank method is a random walk with random resets on a graph. The ranking is based on the probability that a random surfer will visit a certain node at a given time. Important nodes are those nodes linked-to many other important nodes. PageRank of a node in a graph is defined as

$$P ( n ) = α ( \frac{1}{\vert G \vert} + ( 1 - α ) {\sum }_{m ∈ L ( n )} \frac{P ( M )}{C ( m )} )$$

where:

|G|=total number of nodes in a graph;

alpha=random jumping factor (to break dangling nodes with no outgoing edges or loops) random reset;

L(n) is the set of nodes linked to n;

C(m) is the number of outgoing edges on m;

Random reset is described by dangling probability (alpha<1) which determines whether to restart and uniform transitional probability to all nodes is assumed (1/n). With probability alpha, a random node is followed (in case of uniform distribution, each node is chosen with probability 1/n), otherwise one of the edges is followed from the present node. If the random jump is non-uniform (not every node is chosen with same probability as 1/n) it is called personalization—preference vector with respect to nodes. Personalization gives importance to certain nodes, instead of jumping randomly with uniform probability. It increases the probability that a random surfer will stay in the near environment of those preferred nodes.

### PageRank of Nodes with Restart

Random reset in PageRank is based on a uniform distribution of jumping to any node in the graph (1/total number of nodes). For a query-click graph in a particular AdGroup it is possible to compute the PageRank of each node. However, during the earlier pruning step it is possible that some edges linked to the nodes were removed. For example, u1 might have also linked some other candidate (c3) which does not exist in this graph. It is known that p(u1->s1)+p(u1->s2)+p(u1->c1)+p(u1->c3)=1, but c3 is no longer present in the graph. To account for the missing linked candidate it is necessary to keep track of pruned candidates PageRank contribution for every node so that it can be added uniformly to the PageRank of every node.

In each iteration of the PageRank algorithm, it is necessary to visit each node, and update the PageRank of connected node by its contribution (PageRank of current node*weight) For example, node u1 will update PageRank of its connected nodes (s1) by P(u1)*p(u1->s1); P(s1)+=P(u1)*p(u1->s1); P(s2)+=P(u1)*p(u1->s2); P(c1)+=P(u1)*p(u1->c1)

At the end of each iteration, the page rank of each node is updated by taking into random restart and collected missing PageRank mass as shown below.

$${p}^{′} = α ( \frac{1}{\vert G \vert} ) + ( 1 - α ) ( \frac{m}{\vert G \vert} + p )$$

The current PageRank value p is updated to final PageRank value p-prime according to above formula where:
m is missing pagerank mass (due to pruned edges) across all nodes; and
|G| is the total number of nodes in the graph.

The PageRank mass is added due to link traversal to the share of lost PageRank mass that is distributed to each node: m/|G|. The first part of the equation is a random restart with probability alpha (uniform probability of jumping to any node=1/|G|). The initial rank of each node is initially set to zero for all nodes other than source query nodes. For each source query node the PageRank is initially set to its bid ratio with total bid price across all of the source queries.

### Preference Vector in Personalized PageRank

The preference vector introduces a biased random restart in PageRank based on a preference vector of source/candidates nodes in query-click graph.

For candidate queries, it is necessary to take into consideration the commute score computed in the previous step (geometric mean of forward and backward hitting time/hitting probability), how many advertisers are bidding on a query across all AdGroups, and the number of advertisement URLs associated with a candidate. The top candidates are filtered based on the highest commute score and the number of advertisers bidding on the candidate and the URL clicks. The preference probability is generated by normalizing the commute score across the selected candidates.

For source queries, the bid price should be taken into account. Source queries having a higher bid are preferred to those having a lower bid. A weight is computed by dividing the bid-price by the total bid across all queries. The preference vector is then divided between source queries and target queries. In some embodiments, a weight of sixty percent is given to source queries and a weight of forty percent is given to target queries.

### Attributing Candidates to Source Queries

A given AdGroup click group contains Broad and Exact Bidded Terms (aka the Source Queries) and Candidate queries (aka rewrites) linked through URLs. Candidate queries are associated to one of the broad bidded terms based on its hitting probability. Candidate queries are assigned as rewrites to the highest hitting probability among all of the broad bidded terms.

For every source broad bidded term, the hitting probability of each query is calculated with respect to the source broad bidded term. The highest hitting probability and the source candidate for each query are maintained. At the end, for each candidate the highest hitting probability and source is known.

The hitting probability of a query with respect to a source bidded term can be computed by taking random walk along the graph from a candidate query to through the connected URLs. Initially, a hitting probability of 1.0 is assigned to source bidded terms and 0 is assigned to all other candidates. A source query can be reached via 2 hops, 4 hops, or 6 hops, etc. depending on the size of the subgraph. The hitting probability can be expressed as a simple iterative algorithm as follows:

$$\{ \begin{matrix}{h}_{i}^{A} = 1 & for i ∈ A \\ {h}_{i}^{A} = {\sum }_{j ∈ I} {p}_{ij} {h}_{j}^{A} & for i ∉ A\end{matrix}$$

In the algorithm, A is set to contain the source bidded term being evaluated in each iteration (until convergence or 10 iterations). The transitional probability of reaching other candidates via linked URLs is computed. The hitting probability of each query that can be reached from a candidate query is recursively updated.

### Top-K Selection of Rewrites

### Rewrite Utility

Rewrite utility is defined as the information gain that a user can obtain from the search results of a rewrite (query suggestion) according to original query intent. Let's say URLs [Us1, Us2, Us3, . . . , Usn] are associated with an original query from high clicks to low clicks (ie. rank is based on number of clicks). Similarly [Up1, Up2, Up3, . . . , Upn] are associated with rewrite candidate from high clicks to low clicks. The ranking quality of rewrite candidate URLs with respect to source query URLs is found measured using discounted cumulative gain (DCG). The premise of DCG is that highly documents appearing lower in a search result list should be penalized. The graded relevance value is reduced logarithmically proportional to the position of the result. The lower the ranked position of a relevant document, the less useful it is for the user, since it is less likely to be examined. In some embodiments, the discount is 1/log(rank). With base 2, the discount at rank 4 is ½, and at rank 8 it is ⅓. Using the DCG at rank n=r1+r2/log 2+r3/log 3+â¦m/log n (log 2 base), where r1, r2, . . . , m are ratings of documents in rank order.

For the top URLs in results page of qs (source query), the examination probability of URL using rank DCG is

$$p ( e ( {u}_{si} ) = 1 \vert {q}_{s} ) = d ( {u}_{si} , {q}_{s} ) = \frac{1}{{log}_{2} ( {r}_{i} + 1 )}$$

Where r is rank of URL, e is binary random variable whether URL is clicked or not. The examination probability that the user will click the URL in the result page of rewrite candidate query is defined depending on whether this URL appears in results page and where it appears (ranking order compared to source query ranking order).

$$p ( e ( {u}_{si} ) = 1 \vert {q}_{p} ) = \{ \begin{matrix}0 \text{:} & {u}_{si} ∉ {URL}_{p} \\ 1 \text{:} & \begin{matrix}{u}_{si} ⋐ {URL}_{p} , \\ E \{ d ( {q}_{p} , {u}_{si} ) \} \geq E \{ d ( {q}_{s} , {u}_{si} ) \} \\ {u}_{si} ∈ {URL}_{p} ,\end{matrix} \\ \frac{E \{ d ( {q}_{p} , {u}_{si} ) \}}{E \{ d ( {q}_{s} , {u}_{si} ) \}} \text{:} & E \{ d ( {q}_{p} , {u}_{si} ) \} < E \{ d ( {q}_{s} , {u}_{si} ) \}\end{matrix}$$

Finally, pairwise conditional utility can be defined as follows:

$$U ( {q}_{s} \vert {q}_{p} ) = 1 - {\sum }_{u ∈ {URL}_{s}} p ( c ( u ) = 1 \vert {q}_{s} ) p ( e ( u ) = 1 \vert {q}_{p} )$$

This would be close to zero if both source and target queries share similar URLs in the similar ranking order.

### Top-K Rewrites Selection

The original goal is to find the top query rewrites for a given ad group. Each rewrite is already associated with highest transition probability source query. Rewrites can then be filtered based on their utility with respect to the source queries. To do so a sorted list of rewrites based on personalized page rank is first created. A second list of rewrites is created and sorted according to commute score. A group of candidates from the first list is chosen and a group of candidates from the second list is chosen. A filter is applied on conditional utility of candidates with a source query (between 0.3 and 0.9). If the conditional utility of rewrite is less than 0.3, both candidate and source queries have a lot of common URLs. If the conditional utility of rewrite is greater than 0.9, both candidate and source queries may have few common URLs. These rewrites are filtered out since the system is trying to avoid these two extreme cases when ranking rewrites.

### Index Creation

The previously described process may be used to build an index for matching bidded terms with organic queries. Normally an advertiser may have an index of bidded terms and related Ad-Groups. The bidded terms have matching criteria such as EXACT, BROAD, and PHRASE. The candidate queries found by expanding the bid terms are added to the index and assigned a criteria of BROAD expanding the number of possible matches in the index. This index may be used with other traditional methods for matching queries. For example, an ad broker may continue to use query rewriting in combination with this example of query term expansion.

The system and methods described previously provide recognizable benefits over conventional techniques for matching queries with bidded terms and finding ads to serve based on received query. In particular, the described system and methods provides for a system that expands bidded terms using context of the source bidded terms such that the expanded set is of greater value to a user such as an advertiser. The system captures source side context, while maximizing coverage. The system and methods further provide an opportunity to increase relevant ad-coverage and improve click yields leading to increased revenue per search.

From the foregoing, it can be seen that the present disclosure provides systems and methods for building an index for expanding bid terms and selecting advertisements. While various embodiments have been described above, it should be understood that they have been presented by way of example only, and not limitation. It will be apparent to persons skilled in the relevant arts that various changes in form and details can be made therein without departing from the spirit and scope of the invention. Thus, the breadth and scope of the present invention should not be limited by any of the above-described exemplary embodiments, but should be defined only in accordance with the following claims and their equivalents.

1. A method for creating an index for expanding bidded terms, the method comprising:
receiving a group of bid-terms;
accessing a query-uniform resource locator graph, the graph comprising query nodes, uniform resource locator (URL) nodes, and edges modeling transition probabilities between nodes;
extracting a local sub-graph from the query-URL graph for each bid-term among the group of bid-terms to derive a plurality of sub-graphs comprising a bid-term seed node, related URL nodes, and candidate bid-term nodes;
merging the local subgraphs to form a merged graph;
annotating the merged graph with additional information;
computing the sum of probabilities across all paths between each bid-term seed node and each candidate bid-term node;
computing a relevance score for each candidate bid-term node;
constructing a preference vector for the merged graph to bias for highly bidded source terms and relevant bidded candidates;
scoring the candidate bid-term nodes of the merged graph using the preference vector;
computing a probability of reaching a candidate node from a seed node; and
attributing each candidate node of the merged graph to a seed node having the highest probability of reaching the candidate node.

2. The method of claim 1, further comprising:
computing a utility for sets of URLs between each bid term seed node and each candidate bid term node; and
pruning the candidate bid term nodes based on the computed utility.

3. The method of claim 1, further comprising:
computing a probability for each path from a bid term seed node to each related bid term node for each local sub-graph;
pruning the local subgraphs based on the computed probability.

4. The method of claim 1, wherein the query-uniform resource locator graph is derived from a search log.

5. The method of claim 1, wherein the additional information is selected from the list consisting of number of clicks for each query node, the number of advertisers bidding on each query node, the number of clicks to a specific URL for each edge, the total number of queries linked to each URL node, the total number of clicks for each URL, and the total number of linked Queries for each URL.

6. A method for creating an index for expanding bidded terms, the method comprising:
accessing a query-uniform resource locator graph, the graph comprising query nodes, uniform resource locator (URL) nodes, and edges modeling transition probabilities between nodes;
extracting a local sub-graph from the query-URL graph for each bid term among a group of bid terms to derive a plurality of sub-graphs comprising a bid term seed node, related URL nodes, and candidate bid term nodes;
merging the local subgraphs to form a merged graph;
personalizing the merged graph;
computing at least one relevance measure for each candidate bid term node with respect to each bid term seed node; and
ranking the candidate bid term nodes for each bid term seed node, the ranking biased according to commercial relevance.

7. The method of claim 6, further comprising pruning the local sub-graphs prior to merging.

8. The method of claim 6, wherein the query-uniform resource locator graph is derived from a search log.

9. The method of claim 6, wherein ranking the candidates comprises a personalized page rank of the merged graph.

10. A system for serving advertisements related to a user query, the system comprising:
an indexing module configured to:
access a query-uniform resource locator graph, the graph comprising query nodes, uniform resource locator (URL) nodes, and edges modeling transition probabilities between nodes;
extract a local sub-graph from the query-URL graph for each bid term among a group of bid terms to derive a plurality of sub-graphs comprising a bid term seed node, related URL nodes, and candidate bid term nodes;
merge the local subgraphs to form a merged graph;
personalize the merged graph;
computing at least one relevance measure for each candidate bid term node with respect to each bid term seed node; and
rank the candidate bid term nodes for each bid term seed node, the ranking biased according to commercial relevance;
a matching module configured to:
receive a user query;
match the user query with at least one bid term node from among the ranked bid term nodes and a seed bid term node; and
select an advertisement basted on the matched bid term.

11. The system of claim 10, further comprising a storage module configured to store the ranking of the candidate bid term nodes.

12. The system of claim 10, further comprising an ad serving module configured to serve the selected advertisement.

13. The system of claim 10, further comprising a memory storing a search engine log for deriving the query uniform resource locator log.
